(19) United States
(12) Patent Application Publication
(10) Pub. No.: US 2025/0144909 A1
(43) Pub. Date: May 8, 2025

(54) MULTILAYER FILM FOR TEAR-OPEN PACKAGES

(71) Applicant: ADAPA DIGITAL GESMBH, Neudorf (AT)

(72) Inventors: Stefan ZOISTER, Nußdorf am Attersee (AT); Manfred HOCH, Ochsenhausen (DE); Tobias WEGMANN, Wangen (DE)

(73) Assignee: ADAPA DIGITAL GESMBH, Neudorf (AT)

(21) Appl. No.: 18/835,964

(22) PCT Filed: Feb. 10, 2023
(86) PCT No.: PCT/EP2023/053344

§ 371 Date: Aug. 5, 2024

(30) Foreign Application Priority Data
Feb. 11, 2022 (AT) A 50093/2022

(51) Int. Cl. B32B 3/26; B23K 26/402; B32B 7/023; B32B 15/082; B32B 15/085; B32B 27/08; B32B 27/30; B32B 27/32

(52) U.S. Cl. CPC B32B 3/266; B23K 26/402; B32B 7/023; B32B 15/082; B32B 15/085; B32B 27/08; B32B 27/306; B32B 27/32; B32B 2250/03; B32B 2250/05; B32B 2307/4026; B32B 2307/416; B32B 2307/582; B32B 2307/7242; B32B 2307/7376; B32B 2439/70; B32B 2439/80

(57) ABSTRACT

The invention relates to a multilayer film for tear-open packages, the film comprising at least one laser-removable carrier layer and at least one barrier layer. According to the invention, at least one laser stop layer for protecting the at least one barrier layer from removal of the at least one barrier layer by a laser is located between the at least one carrier layer and the at least one barrier layer.

### CROSS-REFERENCE TO RELATED APPLICATIONS

The present application is a national phase application of PCT Application No. PCT/EP2023/053344, filed Feb. 10, 2023, entitled “MULTILAYER FILM FOR TEAR-OPEN PACKAGES”, which claims the benefit of Austrian Patent Application No. A 50093/2022, filed Feb. 11, 2022, each of which is incorporated by reference in its entirety.

### BACKGROUND OF THE INVENTION

### 1. Field of the Invention

The invention relates to a multilayer film for tear-open packaging.

### 2. Description of the Related Art

Single and multilayer film packaging has long been known and are of great importance in the food and pharmaceutical industries in particular.

It is known that commercially available tear-open packaging has a weakened area or a weakened line at which a packaging can be opened, in particular torn open, with little effort in order to access the contents of the package. The slight weakened lines enable easy handling of the tear-open packaging.

A weakened line is a localized weakening of a film material and can be produced, for example, by precision die-cutting. Lasers, in particular CO₂ lasers, can also be used to form weakened lines. The weakened line is created by reducing the local film layer thickness or by lacquering the film material.

The disadvantage of this is that in the so-called “laser scribing”, the scribing of the film to create a weakened line and make it easier for the user to open the packaging, a barrier layer of the film is often damaged, which means that there is no longer an effective barrier against an external atmosphere. This is particularly the case when using similar polymer types, where the laser cannot recognize any difference between the material to be removed on the outside of the film composite and the barrier layer on the inside, which is to remain intact. If the barrier layer is removed or damaged, oxygen and moisture can penetrate the contents of the packaging and damage the packaged goods.

### SUMMARY OF THE INVENTION

The object of the invention is therefore to provide a multilayer film for tear-open packaging of the type mentioned above, with which the disadvantages mentioned can be avoided, with which a tear-open packaging can be easily opened and with which the tear-open packaging has an intact barrier layer in the unopened state.

The fact that at least one laser stop layer is provided to protect the at least one barrier layer against ablation of the at least one barrier layer by a laser between the support layer and the at least one barrier layer has the advantage that the contents of the tear-open packaging are protected from the atmosphere surrounding the tear-open packaging, thereby preventing the penetration of harmful substances such as moisture, acid and also the penetration of viruses and bacteria into the packaging. The barrier layer is not damaged by the laser when a weakened area or weakened line is created in the support layer, which means that the packaging contents remain protected from the aforementioned external influences and the shelf life of the packaging contents is not reduced. This is particularly important for food and medical or pharmaceutical products. Furthermore, this enables the tear-open packaging to be opened safely and easily.

The invention also relates to a method for forming a weakened area in a multilayer film.

The invention therefore also has the task of providing a method for forming a weakened area in a multilayer film using a laser, with which the disadvantages mentioned can be avoided, with which it is possible to simply form a weakened area of a tear-open packaging while maintaining an intact barrier layer of the tear-open packaging.

The advantages of the method correspond to the advantages of the multilayer film mentioned above.

The dependent claims relate to further advantageous embodiments of the invention.

Expressive reference is hereby made to the wording of the patent claims, whereby the patent claims are incorporated into the specification at this point by reference and are deemed to be reproduced verbatim.

### BRIEF DESCRIPTION OF THE DRAWINGS

The invention is described in more detail with reference to the enclosed drawings, in which only preferred embodiments are shown by way of example. Showing:

FIG. 1 an exemplary representation of a first preferred embodiment of a multilayer film comprising a support layer, a barrier layer and a laser stop layer as a section and

FIG. 2 an exemplary representation of a second preferred embodiment of a multilayer film comprising a support layer, two sealing layers, two barrier layers and two blocking layers, wherein the blocking layers form a laser stop layer, as a section.

### DETAILED DESCRIPTION

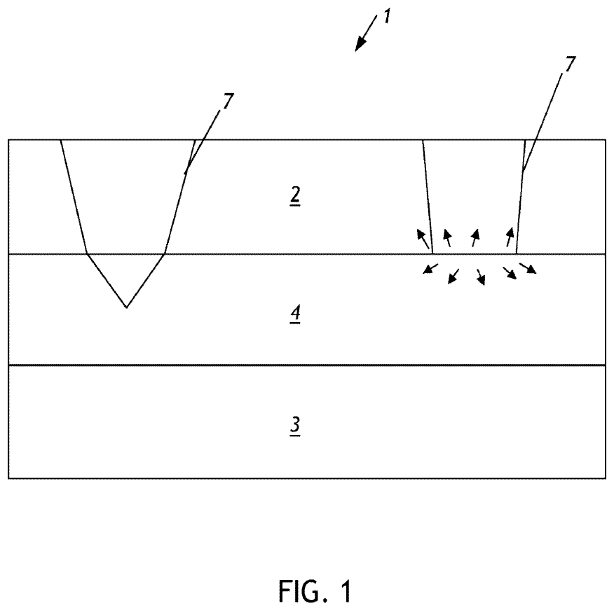

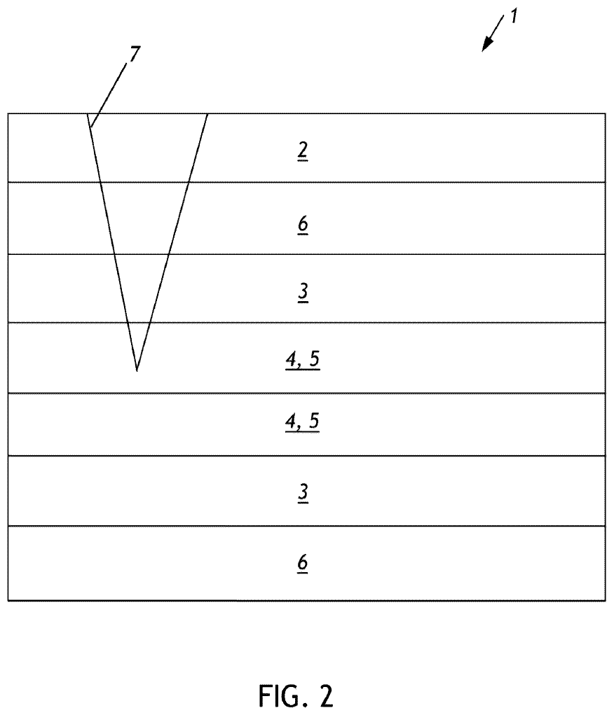

FIGS. 1 and 2 show at least parts of a multilayer film 1 for tear-open packaging, wherein the film 1 comprises at least one laser-ablatable support layer 2 and at least one barrier layer 3, wherein at least one laser stop layer 4 is arranged between the at least one support layer 2 and the at least one barrier layer 3 to protect the at least one barrier layer 3 against ablation of the at least one barrier layer 3 by a laser.

Furthermore, a method for forming a weakened area in a multilayer film 1 using a laser is proposed, wherein the laser ablates at least one support layer 2 of the multilayer film 1 in a weakened area, wherein the laser strikes at least one laser stop layer 4 arranged between the at least one support layer 2 and at least one barrier layer 3 in the weakened area, wherein the laser power 7 in the at least one laser stop layer 4 is locally attenuated in such a way that the at least one barrier layer 3 is not ablated by the laser.

A tear-open packaging comprising a multilayer film 1 is also provided. The tear-open packaging comprises the multilayer film 1, wherein at least one weakened area, in particular at least one weakened line, is incorporated in the support layer 2. This makes it easier for a user to open the packaging at the weakened area or along the weakened line.

The fact that at least one laser stop layer 4 is arranged between the support layer 2 and the at least one barrier layer 3 to protect the at least one barrier layer 3 from ablation by a laser results in the advantage that the package contents of tear-open packages are protected from the atmosphere surrounding the tear-open package, which prevents the penetration of harmful substances such as moisture, oxygen and also the penetration of viruses and bacteria into the package. The barrier layer 3 is not damaged by the laser when a weakened area or weakened line is created in the support layer 2, which means that the packaging contents remain protected from the aforementioned external influences, so that the shelf life of the packaging contents is not reduced. This is particularly important for food and for medical or pharmaceutical products. Furthermore, this enables the tear-open packaging to be opened safely and easily.

It may preferably be provided that the laser is a CO₂ laser. The weakened area can be formed particularly well using a CO₂ laser.

The multilayer film 1 comprises several layers, which are not joined together in a non-destructively detachable manner. The at least one support layer 2 of the multilayer film 1 can be removed by a laser. The ablation of the at least one support layer 2 preferably only takes place in an area to be removed, the so-called weakened area or along the so-called weakened line, along which the multilayer film 1 can be torn open in a processing or usage state, namely as tear-open packaging. The support layer 2 ensures the mechanical strength of the multilayer film 1. The tensile strength of the support layer 2 is preferably higher than that of the other individual layers. Preferably, only a single support layer 2 is provided. However, two or more support layers 2 can also be provided, at least one of which can be ablated by the laser.

Furthermore, the multilayer film 1 comprises at least one barrier layer 3, which preferably forms a packaging inner side of a tear-open packaging in the processing or use state of the multilayer film 1.

The at least one barrier layer 3 protects the contents of the packaging from the external atmosphere surrounding the tear-open packaging. The at least one barrier layer 3 is preferably impermeable to oxygen and/or impermeable to moisture.

It may preferably be provided that the multilayer film 1 comprises several barrier layers 3. The barrier layers 3 can preferably be connected or attached to each other.

Alternatively, other layers can be arranged between the individual barrier layers 3.

The at least one barrier layer 3 can preferably comprise ethylene vinyl alcohol copolymer (EVOH) or consist of EVOH.

The packaging can preferably be packaging for food, medical products, pharmaceutical products or other consumer goods.

The multilayer film 1 further comprises at least one laser stop layer 4, which is arranged between the at least one support layer 2 and the at least one barrier layer 3 to protect the at least one barrier layer 3 from laser ablation. The at least one laser stop layer 4 causes absorption and/or reflection and/or scattering of the laser beam in the at least one laser stop layer 4. A combination of the effects described can also be used. The at least one laser stop layer 4 is designed in such a way that ablation of the at least one barrier layer 3 is avoided. The at least one laser stop layer 4 attenuates or reduces the local laser power 7 to such an extent that the at least one barrier layer 3 is not ablated. The at least one barrier layer 3 thus remains intact after the multilayer film 1 has been processed with a laser and the protective effect of the at least one barrier layer 3 for the packaging contents is thus retained.

A simple structure of a first preferred embodiment of a multilayer film 1 with a laser stop layer 4 arranged between a support layer 2 and a barrier layer 3 is shown by way of example in FIG. 1. FIG. 1 also shows an example of the change in laser power 7 as the individual layers are penetrated. FIG. 1 shows on the left-hand side the case where the laser power 7 decreases due to absorption in the laser stop layer 4 and is completely absorbed. The right-hand side shows the case where the laser beam is reflected and scattered in the boundary area between the support layer 2 and the laser stop layer 4, which is indicated by the arrows. In both cases, no more laser power 7 appears in the barrier layer 3.

The thickness ratios of the layers shown in the figures do not correspond to the actual thickness ratios.

It may be particularly preferable for the at least one support layer 2 and the at least one barrier layer 3 to consist of a jointly recyclable material. This means that the support layer 2 and the barrier layer 3 can be recycled together and no costly steps need to be taken to separate these layers before recycling.

The jointly recyclable material can in particular be the same polymer or the same plastic. The at least one support layer 2 and the at least one barrier layer 3 can therefore consist of the same polymer or the same plastic.

The at least one laser stop layer 4 can be single-layered or multi-layered. In the case of a multilayer design, several interconnected layers preferably form the laser stop layer 4.

Preferably, it can be provided that the thickness of the at least one laser stop layer 4 is less than 6 μm, in particular less than 3 μm, preferably less than 1 μm. Such thicknesses are already sufficient to stop the laser beam or to sufficiently reduce the local laser power 7 in the at least one laser stop layer 4 so as not to ablate the barrier layer 3.

It may be particularly preferable for the at least one laser stop layer 4 to comprise at least one laser-absorbing substance, in particular at least one inorganic pigment or at least one organic dye. The laser beam hitting the laser stop layer 4 is absorbed by the laser stop layer 4. As a result, the at least one barrier layer 3 arranged after the at least one laser stop layer 4 is not removed and the at least one barrier layer 3 remains intact. The inorganic pigments preferably include transparent, colored, fluorescent and phosphorescent pigments.

It may also preferably be provided that the at least one laser stop layer 4 comprises at least one laser-reflecting substance, in particular at least one metal. This allows the laser or at least a large part of the laser beam, and thus also the laser power 7, of the laser to be reflected, as a result of which the at least one barrier layer 3 arranged under the at least one laser stop layer 4 is not removed and remains intact. The laser-reflecting substance preferably comprises aluminum, copper, platinum, gold, silver, aluminum oxides (AlOx) and silicon oxides (SiOx metalized).

Preferably, it can also be provided that the at least one laser stop layer 4 comprises at least one structure for scattering laser beams. By scattering the laser beam, it can be attenuated to such an extent that the laser does not ablate the at least one barrier layer 3 and the at least one barrier layer 3 remains intact.

The laser stop layer 4 can preferably be formed as the surface structure of the support layer 2 and/or the barrier layer 3.

It is possible that the at least one laser stop layer 4 is produced by cross-linking. Cross-linking creates a three-dimensional structure. This cross-linking causes the laser beam to scatter on the three-dimensional structure, which attenuates the laser beam. Cross-linking of partial areas of the multilayer film 1 may be preferred. The surfaces that are not to be cross-linked are covered by masks that are printed on or drawn over the cross-linking device. The masks can be made of metal coatings. Cross-linked and non-cross-linked areas can be combined by means of lamination. Preferably, the mechanical properties of the multilayer film 1, in particular its durability and printability, can be improved by partial crosslinking.

The raw materials for cross-linking must be adjusted for good cross-linkability. The degree of cross-linking is controlled by the power of the cross-linking system. Cross-linking can be generated using electron beams, ultraviolet rays (UV), X-rays and magnetic waves.

It may preferably be provided that the at least one laser stop layer 4 has one or more embossments or is formed by one or more embossments. The embossing can create structures that deflect or scatter the laser beam, thereby attenuating the laser power of the laser beam.

However, it may also be provided that the at least one laser stop layer 4 is printed on, which makes it easy to produce the at least one laser stop layer 4. Printing can preferably be carried out using defined modified screen dots, analogous to the Digimarc printing technique.

Preferably, the at least one laser stop layer 4 can be printed by means of gravure printing, flexographic printing, digital printing, offset printing or screen printing. It is also possible that the at least one laser stop layer 4 is formed using two or more than two of the aforementioned printing methods. This can be the case in particular with a multilayer laser stop layer 4.

It is also possible for the at least one laser stop layer 4 to be produced fully flat on the at least one barrier layer 3 by means of anilox rolling and/or smooth rolling with and against each other or by means of reverse engraving.

It may preferably be provided that the at least one laser stop layer 4 further comprises one or more of the following compounds and/or elements and/or modifications, namely silica in the master patch, ethylene vinyl alcohol copolymer (EVOH), acrylates, polyvinyl alcohol (PVOH), conductive pigments such as conductive carbon and/or silver and/or tin and/or antimony, magnetizable pigments such as magnetite and/or organic and inorganic imprints.

For example, the at least one laser stop layer 4 may comprise at least one pigment or at least one dye and/or an organic or inorganic binder and at least one solvent.

It is also possible that the at least one laser stop layer 4 is only partially arranged in the area of the at least one barrier layer 3 in which the laser beam is to be stopped. The weakened area or the weakened area is preferably specified. Accordingly, the at least one laser stop layer 4 can preferably be arranged only in this area of the multilayer film 1, which can save costs and resources.

It may be provided that the at least one laser stop layer 4 forms the weakened area or weakened line in such a way that several, for example point-shaped, weakened areas are arranged along the weakened line. However, it is also possible for the weakened area to have a weakened line that is essentially continuous over the weakened area. The at least one laser stop layer 4 is arranged specifically at the points or areas where the laser beam is to be stopped.

Alternatively, it can be provided that the at least one laser stop layer 4 is arranged completely flat, which makes it easy to produce the multilayer film 1.

It is also possible that the at least one laser stop layer 4 is vapor-deposited. For example, a vapor-deposited metal layer can be structured using etching processes or other metal-removing processes or masking.

In particular, it may preferably be provided that the at least one laser stop layer 4 consists of a material which can be recycled together with the at least one support layer 2 and the at least one barrier layer 3. This means that the multilayer film 1 can be easily recycled and there is no need to separate different plastics. This means that even strict recycling requirements can be easily met. Polymers of the same type are essential for a functioning circular economy and therefore for the recyclability of multilayer film 1. By reducing the material components of the multilayer film 1, the recyclability of the same can be optimized.

It may preferably be provided that the at least one laser stop layer 4 is formed as a surface structure of the at least one barrier layer 3 and/or the at least one support layer 2. The surface of the laser stop layer 4 and/or at least one barrier layer 3 can, for example, have a structure and/or inorganic pigments and/or a metal coating. This allows the at least one laser stop layer 4 to be formed particularly thinly.

For this purpose, it may be provided that the at least one laser stop layer 4 covers the entire surface of the at least one barrier layer 3 or that it is partially arranged in the weakened area or along the weakened line.

It may also preferably be provided that the multilayer film 1 comprises at least one additional ablation layer. The at least one ablation layer can preferably be arranged on the at least one support layer 2, which is not shown in the figures.

Alternatively, the at least one ablation layer can be formed as a part of the at least one support layer 2 or the at least one ablation layer can correspond to the at least one support layer 2.

The at least one ablation layer can preferably be equipped with additives that enable easier absorption of the laser beam. Downstream of the at least one ablation layer, there is preferably a layer that absorbs the laser beam more strongly, which enables precise control of the penetration depth of the laser beam. The additives used for the at least one ablation layer can be applied or introduced by blow, flat or extrusion coating and by printing.

The at least one ablation layer can be applied partially and thus only to certain areas of the multilayer film 1, in particular partially to certain areas of the at least one support layer 2. The additives used here facilitate the penetration of the laser steel. The additives can also strengthen the laser beam. Additives to strengthen the laser beam include, in particular, polyethylene terephthalate (PET) and/or polyamide. The laser beams can be further amplified by adding glass fibers.

It may be provided that the multilayer film 1 comprises at least one additional sealing layer 6. This sealing layer 6 can in particular form the inside of the packaging, which is shown as an example in FIG. 2. Furthermore, the sealing layer 6 may be adjacent to the barrier layer 3. The at least one sealing layer 6 can preferably be made of polyethylene or polypropylene.

Furthermore, it may be particularly preferable for the film 1 to have two interlocking layers 5, which form a non-destructively detachable interlocking of two layers, with the laser stop layer 4 comprising the two interlocking layers 5. The blocking layers 5 form at least a part of the at least one laser stop layer 4 or the laser stop layer 4 completely. Such a blocking can be produced, for example, by means of a blown film extrusion line at a predefined temperature and pressure. Preferably, each of the layers can have the same design. Furthermore, it can be provided that each layer has a barrier layer 3 and a blocking layer 5. A complex layer structure can easily be created by blocking, in which the blocking layers 5 are arranged between two barrier layers 3. Here, one of the barrier layers 3 can be removed by the laser beam, as another intact barrier layer 3 remains in place. A multi-layered and absorbent area can easily be provided in the multilayer film 1 by blocking.

An example of a multilayer film 1 produced by blocking technology is shown in FIG. 2. This multilayer film 1 essentially comprises two layers. Both layers have a sealing layer 6, a barrier layer 3 arranged on the sealing layer 6 and a blocking layer 5 arranged on the barrier layer 3, wherein the two layers are joined together in the blocking layer 5 and the blocking layers 5 form the laser stop layer 4. In addition, a support layer 2 is arranged on one of the layers.

The sealing layers 6 can preferably comprise polyethylene or polypropylene or consist of polyethylene or polypropylene. In particular, the sealing layers 6 can be fusible layers, allowing a packaging to be closed. For example, two sealing layers 6 can be fused together to seal a package.

The blocking layers 5 can preferably comprise ethylene-vinyl acetate copolymer (EVA) or consist of EVA. The barrier layers 3 shown in FIG. 2 form a barrier to oxygen and moisture and protect the contents of the packaging from oxygen and moisture. At least one barrier layer 3 facing the packaging contents remains intact during and after the creation of the weakened area by means of the laser.

A laser beam penetrating through the support layer 2 and through a first sealing layer 6 is stopped in the laser stop layer 4, which in the second preferred embodiment is formed by two blocking layers 5. The laser beam is indicated by a triangle in FIG. 2. Thus, in this example, a barrier layer 3 facing the packaging contents and a sealing layer 6 facing the packaging contents remain intact. A packaging can be fused to the sealing layer 6 during its manufacture, with the intact barrier layer 3 protecting the packaging contents from oxygen and moisture.

The following are principles for understanding and interpreting objective disclosure.

Characteristics are usually introduced with an indefinite article “a, an”. Unless the context indicates otherwise, “a, an” is therefore not to be understood as a number word.

The connective word “or” is to be interpreted as inclusive and not exclusive. Unless the context indicates otherwise, “A or B” also includes “A and B”, where “A” and “B” are arbitrary characteristics.

1-12. (canceled)

13. A multilayer film for tear-off packaging, comprising:
at least one laser-ablatable support layer;
at least one barrier layer; and
at least one laser stop layer for protecting the at least one barrier layer from ablation of the at least one barrier layer by a laser arranged between the at least one support layer and the at least one barrier layer.

14. The multilayer film according to claim 13, wherein the at least one laser stop layer comprises at least one laser-absorbing substance.

15. The multilayer film according to claim 14, wherein the at least one laser stop layer comprises at least one of at least one inorganic pigment and at least one organic dye.

16. The multilayer film according to claim 13, wherein the at least one laser stop layer comprises at least one laser-reflecting substance.

17. The multilayer film according to claim 16, wherein the at least one laser stop layer comprises at least one metal.

18. The multilayer film according to claim 13, wherein the at least one laser stop layer comprises at least one structure for scattering laser beams.

19. The multilayer film according to claim 13, wherein the at least one laser stop layer is arranged only partially in relation to that region of the barrier layer in which the laser beam is to be stopped.

20. The multilayer film according to claim 13, wherein the at least one support layer and the at least one barrier layer consist of a jointly recyclable material.

21. The multilayer film according to claim 20, wherein the at least one laser stop layer consists of a material which can be recycled together with the at least one support layer and the at least one barrier layer.

22. The multilayer film according to claim 13, wherein the at least one laser stop layer is formed as a surface structure of the at least one barrier layer and/or the at least one support layer.

23. The multilayer film according to claim 13, wherein:
the film has two interlocked interlocking layers which form a non-destructively releasable interlocking of two layers; and
the laser stop layer comprises the two interlocking layers.

24. A tear-open packaging comprising a multilayer film according to claim 13.

25. A method for forming a weakened area in a multilayer film with a laser, comprising:
ablating by the laser at least one support layer of the multilayer film in a weakened area;
striking by the laser strikes at least one laser stop layer arranged between the at least one support layer and at least one barrier layer in the weakened area;
wherein the laser power in the at least one laser stop layer is locally attenuated in such a way that the at least one barrier layer is not ablated by the laser.

26. The method according to claim 25, wherein the weak area ends at the at least one laser stop layer and in that the laser does not ablate the at least one laser stop layer.
